(19) United States
(12) Patent Application Publication
(10) Pub. No.: US 2012/0094793 A1
(43) Pub. Date: Apr. 19, 2012

(54) BELT TENSIONING UNIT

(75) Inventor: Hans Bauer, Wilhermsdorf (DE)

(73) Assignee: SCHAEFFLER TECHNOLOGIES GMBH & CO. KG, Herzogenaurach (DE)

(21) Appl. No.: 13/378,146

(22) PCT Filed: Jul. 15, 2010
(86) PCT No.: PCT/EP10/60219

§ 371 Date: Dec. 14, 2011

(30) Foreign Application Priority Data
Aug. 13, 2009 (DE) 102009037402.7

(51) Int. Cl. F16H 7/12

(52) U.S. Cl. 474/117

(57) ABSTRACT

A belt tensioning unit (1′), in particular for a belt pulley plane of an internal combustion engine, including a base part (2) arranged in a rotationally fixed manner and a tensioning part, which is mounted on the base part (2) and can perform relative rotations to a limited extent about a rotation angle (α) with respect to the base part against the action of at least one torsion spring (6). During a relative rotation between the base part (2) and tensioning part, the at least one torsion spring (6) forms a frictional engagement by changing a diameter thereof via a friction device (8a) formed by at least one friction segment (9) acted on by the at least one torsion spring (6) and a friction surface (10a) provided on the tensioning part. In order to design the frictional torque of the friction device (8a) for the entire operating range of the belt tensioning unit (1′), in addition to the nominal position, according to the invention the friction properties of the friction surface (10a) are set to vary depending on the rotation angle (α).

### BACKGROUND

The invention relates to a belt tensioning unit, particularly for a belt pulley plane of an internal combustion engine with a base part arranged in a rotationally fixed manner and a tensioning part, which is mounted on the base part via a hub and can perform relative rotation to a limited extent about a rotation angle with respect to said base part against the action of at least one torsion spring, wherein during a relative rotation between the base part and the tensioning part, the at least one torsion spring forms a frictional engagement by changing a diameter thereof by means of a friction device consisting of at least one friction segment acted on by the at least one torsion spring and a friction surface provided on the tension part.

From DE 10 2005 052 453 A1 a generic belt tensioning unit is known, particularly for a belt pulley plane of an internal combustion engine with a base part, to be arranged in a rotationally fixed fashion in reference thereto, and a tensioning part, such as a tensioning lever with a tensioning roller, rotational in reference to the base part against the action of a torsion spring, such as coil spring, said tensioning part being impinged in the direction of tensioning by the coil spring. One end of the torsion spring is received by the base part and at the other end by the tensioning device, so that upon rotation it is impinged with a tangential force and during a relative motion in the pre-tensioning direction of the torsion spring it expands with regards to its diameter and in the relaxing direction the diameter it contracts. A friction device is provided at the exterior circumference of the torsion spring, controlled by the normal force created by the expanding torsion spring, which is formed by a friction segment impinged by the torsion spring in reference to a friction surface provided on the tensioning part.

The design of the generic belt tensioning units in reference to the tension of the torsion spring and the damping of the friction device occur for the nominal position of the belt tensioning unit in the traction mechanism drive. Thus, via the design of the torsion spring an increasing friction moment with an increasing damping is observed in the direction of the pre-stressing via the rotation angle of the tensioning part in reference to the base part by the continuously increasing normal force caused by the relative rotation, while in the relaxing direction of the torsion spring due to the reducing diameter therefore a reducing normal force with a reducing friction moment occurs and thus, with an increasing rotation angle in the relaxing direction, a reduced damping by the friction device must be tolerated.

### SUMMARY

Accordingly, there is the objective to provide a belt tensioning unit, which is adjusted over the entire rotation angle of the tensioning part in reference to the base part to the tensioning and damping requirements of the traction mechanism drive, particularly the features of the internal combustion engine driving the traction mechanism drive.

This objective is attained in a belt tightening unit, particularly for a belt pulley plane of an internal combustion engine with a base part arranged in a rotationally fixed manner and a tensioning part, which is mounted on the base part and can perform relative rotation to a limited extent about a rotation angle with respect to said base part against the action of at least one torsion spring, wherein during a relative rotation between the base part and tensioning part, the at least one torsion spring forms a frictional engagement by changing the diameter thereof by means of a friction device formed by at least one friction segment acted on by the at least one torsion spring and a friction surface provided on the tension part and the friction features of the friction surface being adjusted in a variable fashion, depending on the rotation angle. By changing the friction features of the friction surface via the rotation angle, independent from the torsion spring, the desired friction moment of the friction device can be provided via the normal force of the rotation angle. It has shown that, to the extent desired, even in case of the diameter of the torsion spring reducing with an increasing rotation angle in the relaxing direction of the torsion spring and thus a lowering normal force the rotation angle with a respective embodiment of the friction features of the friction surface a progressive friction moment can be provided.

According to the invention the friction surface is profiled depending on the rotation angle. This can be understood essentially as two types of adjusting the friction surface to the normal force of the changing torsion spring via the rotation angle, which can be used either individually or in combination.

The first type of adjustment relates to a change of the friction radius of the friction surface depending on the rotation angle. Here, it is deviated from the known cylindrical embodiment of the interior circumference of the friction surface implemented at the tensioning part and an interior circumference of the friction surface is provided adjusted via the rotation angle to the requirements of the desired friction moment. Depending on the direction of rotation of the tensioning part, with an increasing rotation angle a friction moment can be created increasing the normal force of the torsion spring and being progressive as well as a friction moment weakening the normal force and being digressive. It is understood that regardless of the diameter of the torsion spring reducing or increasing depending on the direction of rotation by an appropriate embodiment of the friction radius in both directions of rotation the tensioning part can be embodied with the same friction parameters depending on the rotation angle.

According to an advantageous exemplary embodiment, based on a nominal position, continuous friction radii can be provided. For example, in the direction of rotation with a relaxation of the torsion spring the friction radius can be reduced over the rotation angle. This leads to a compensating effect in the relaxation range of the torsion spring by the normal force being reduced by the smaller diameter so that the friction moment, depending on the gradient of the friction radius reducing over the rotation angle, the digression of the friction power is smaller in reference to a cylindrically embodied friction surface, remains the same, or develops even progressively. Alternatively it may be provided to embody the friction radius increasing in the direction of rotation towards a relaxation of the torsion spring over the rotation angle, so that in any case a digressively developing friction parameter can be provided in reference to a cylindrical embodiment of the friction surface with a friction radius constant over the rotation angle.

Independent from the embodiment of the friction radius in the direction of relaxation, the friction radius can be provided reducing over the rotation angle in the direction of rotation of a pre-stressing of the torsion spring so that, depending on the embodiment of the gradient of the friction radius over the rotation angle, an increasing progressive friction parameter can be shown with the friction moment increasing over-proportionally over the rotation angle. A flatter friction parameter with weakly progressive to linear to digressive parameters can be achieved via a friction radius increasing over the rotation angle in the direction of rotation of the pre-stressing of the torsion spring.

The second type of change of the friction power of the friction surface over the rotation angle can occur via a texture of the friction surface depending on the rotation angle. For this purpose, the microscopic friction surface can be varied over the rotation angle, by for example its texture being varied over the rotation angle. For example, different depths of roughness or a geometric alignment of the texture, for example in the form of cut grooves or flutes or their density may be provided depending on the rotation angle. Furthermore, positive surface parts forming the friction engagement with the friction segment may be varied over the rotation angle in reference to the negative surface portions, such as indentations or grooves. Furthermore, an axial projection provided at the tensioning part and forming a friction surface may be widened or narrowed over the rotation angle so that via the rotation angle the surface of the friction segment only forms a complete frictional engagement with a high friction moment with the friction surface at a predetermined rotation angle, while at other rotation angles it partially projects axially.

By the profiling of the friction surface arranged at the base part, for example by the embodiment in a non-cylindrical form, simultaneously the progression of the pre-tightening force of the torsion spring can be adjusted, with the friction surface simultaneously forming the contact surface for the torsion spring. Here, the moment of the torsion spring and thus the damping developing changes positively. Particularly in unfavorable lever ratios of the tensioning lever, for example in edge positions of the tensioning lever, a belt force develops with an improved effect upon the belt. Furthermore, hereby the parameter of damping of the belt tensioning unit can be adjusted in a targeted fashion and/or a tension snapping can be yielded by a targeted braking of the tensioning lever via a progressive embodiment of the spring moment using a respective profiling of the friction surface.

### BRIEF DESCRIPTION OF THE DRAWINGS

In the following, a preferred embodiment of a belt tensioning unit embodied according to the invention is explained in greater detail with reference to the attached drawings. Shown here are:

FIG. 1 a belt tensioning unit in a cross-section, and

FIG. 2 a schematic illustration of a section of a belt tensioning unit with friction surfaces profiled over the rotation angle.

### DETAILED DESCRIPTION OF THE PREFERRED EMBODIMENTS

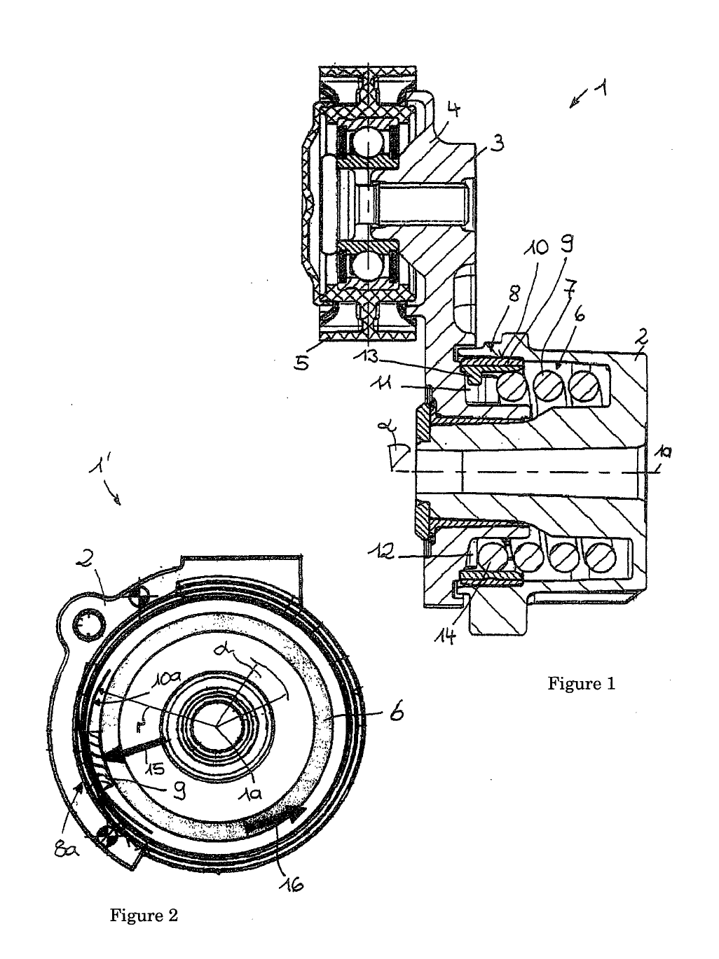

FIG. 1 shows a belt tensioning unit 1 for a state of the art traction mechanism device having a base part 2, arranged locally fixed for example at a housing of an internal combustion engine, and a tensioning part 3, that is movable to a limited extent in reference thereto about the rotary axis 1a, which here is embodied as the pivot arm 4 that receives the tensioning roller 5 in a rotational fashion. The tensioning roller 5 engages the wrapping means, for example a belt, and adjusts its pre-tension and dampens any vibrations introduced into the traction mechanism device by pivoting the pivot arm 4. A force compensating the tension of the wrapping means is here applied between the base part 2 and the pivot arm 4 by a torsion spring 6 extending between them. In the exemplary embodiment shown it is formed by a coil spring 7, which at its one end is connected in a torque-proof fashion with the base part 2 and at its other end in a torque-proof fashion with the pivot arm 4 via entraining devices, with FIG. 1 only showing the entraining device 11 of the pivot arm 4 formed axially in the direction of the coil spring 7.

In order to dampen vibrations occurring in the traction mechanism device, which stress the belt tensioning device 1 by more or less rhythmic pivotal motions of the pivot arm 4, during a rotation such as a partial rotation or pivoting of the pivot arm 4 in reference to the base part 2, a friction device 8 is interposed, which is formed from the friction segment 9 and a friction surface 10 embodied complementary and provided at the interior circumference of the base part 2. Here, during a relative motion about the rotation angle α between the pivot arm 4 and the base part 2, the friction segment 9 is entrained by the pivot arm 4 via another entraining device 12 provided at the pivot arm 4, which may be formed in a simple design by the entraining device 11 for the coil spring 7. This spring axially engages the friction segment 9 and entrains it in a rotary-fixed fashion at the flange 13 projecting inwardly. Here, as shown, the flange 13 can be entrained in the circumferential direction by the entraining device 12, with the flange 13 engaging axially into an entraining device 12 embodied as a recess and thus being entrained in both directions of rotation.

The friction segment 9 can be installed being a pre-stressed or with slight air play in reference to the friction surface 10. Impinging the friction segment 9 in reference to the friction surface 10 occurs via a normal force of the torsion spring 6, which during the rotation of the pivot arm 4 expands in reference to the base part 2. Here, one or more windings 14 of the torsion spring 6 contact the interior circumference of the friction segment 9 and determine, by the normal force of the torsion spring 6 acting thereupon, the friction moment increasing with the rotation angle of the pivot arm 4 between the friction segment 9 and the friction surface 10, thus between the pivot arm 4 and the base part 2.

The torsion spring 6 is designed with regards to stiffness such that the pivot arm 4 counters the vibration moments of the belt and the pre-stressing force of the belt. Depending on the predetermined structural space the torsion spring 6 is expanded when the pivot arm 4 rotates due to the vibrations of the drive shaft. The normal force resulting and acting upon the friction device 8 is here dependent on the stiffness of the torsion spring 6 and thus its torsion force.

In the belt tensioning unit 1 embodied according to prior art the friction surface 10 shown is embodied cylindrically about the rotary axis 1a, i.e. having a constant friction radius, so that in case of a rotation in the relaxing direction of the torsion spring 6 with a reducing diameter the friction moment reduces with an increasing rotation angle α and in the pre-stressing direction of the torsion spring 6 with an increasing diameter it increases over-proportionally with the rotation angle α increasing in this direction of rotation.

FIG. 2 shows schematically a belt tensioning unit 1′, according to the inventive concept, similar to the belt tensioning unit 1 of FIG. 1 except for the differences described in the following, with the base part 2 and the friction surface 10a, varying from the tensioning part according to the invention, not shown in greater detail, which here is only schematically indicated. The friction surface 10a is in a friction-fitting engagement with the friction segment 9, which is impinged by a normal force acting by the rotation of the tension part and the base part 2 about the rotation angle α in the direction of the arrow 15, with the torsion spring at its ends being supported, on one side, by the tension part, and the tension part 3 (FIG. 1), each via a tangential force effective along the arrow 16, and thus expands with regards to its diameter. In reference to the axis of rotation 1a the friction surface 10a comprises a friction radius r changing over the rotation angle α. This way, depending on the embodiment of the friction radius r, with an increasing rotation angle α the normal force, depending on said angle, is compensated or emphasized by the torsion spring 6 expanding in the pre-stressing direction and/or contracting in the direction of relaxation. This way, by selecting the embodiment of the profiling of the friction surface 10a the parameters of the friction device 8a can be adjusted, which are not predetermined by the design of the belt tensioning unit 1′ but are embodied according to the features of the traction mechanism device and the internal combustion engine driving it.

It is understood that in an appropriately designed torsion spring 6 its diameter reduces in the pre-stressing direction and expands in the direction of relaxation, with for such embodiments an appropriately profiled friction surface 10 being included in the scope of the inventive idea.

### LIST OF REFERENCE CHARACTERS

1 Belt tensioning unit
1′ Belt tensioning unit
1a Rotary axis
2 Base part
3 Tensioning part
4 Pivot arm
5 Tensioning roll
6 Torsion spring
7 Coil spring
8 Friction device
8a Friction device
9 Friction segment
10 Friction surface
10 Friction surface
11 Entraining device
12 Entraining device
13 Flange
14 Winding
15 Arrow
16 Arrow
α Rotation angle
r Friction radius

1. A belt tightening unit for a belt pulley plane of an internal combustion engine, comprising a base part, arranged in a torque-proof fashion on the internal combustion engine, and a tensioning part, which is mounted on the base part and can perform a relative rotation to a limited extent about a rotation angle (α) with respect to said base part against an action of at least one torsion spring, wherein during a relative rotation between the base part and the tensioning part the at least one torsion spring forms a frictional engagement by changing a diameter thereof by a friction device formed by at least one friction segment acted on by the at least one torsion spring and a friction surface provided on the tensioning part, and friction features of the friction surface are adjusted in a variable fashion, depending on the rotation angle (α).

2. A belt tightening unit according to claim 1, wherein the friction surface is profiled depending on the rotation angle (α).

3. A belt tightening unit according to claim 1, wherein a friction radius (r) of the friction surface is varied depending on the rotation angle (α).

4. A belt tightening unit according to claim 3, wherein the friction radius (r) reduces over the rotation angle (α) in a direction of rotation of a relaxation of the torsion spring.

5. A belt tightening unit according to claim 3, wherein the friction radius increases over the rotation angle in a direction of rotation of a relaxation of the torsion spring.

6. A belt tightening unit according to claim 3, wherein the friction radius (r) reduces over the rotation angle (α) in a direction of rotation of a pre-stressing of the torsion spring.

7. A belt tightening unit according to claim 3, wherein the friction radius increases over the rotation angle in a direction of rotation of a pre-stressing of the torsion spring.

8. A belt tightening unit according to claim 2, wherein a texture of the friction surface is varied over the rotation angle.

9. A belt tightening unit for a belt pulley plane of an internal combustion engine, comprising a base part, arranged in a torque-proof fashion on the internal combustion engine, and a tensioning part, which is mounted on the base part and can perform relative rotation to a limited extent about a rotation angle (α) with respect to said base part against an action of at least one torsion spring, wherein during a relative rotation between the base part and the tensioning part the at least one torsion spring forms a frictional engagement by changing a diameter thereof via a friction device formed by at least one friction segment acted on by the at least one torsion spring and a friction surface provided on the tension part, and the friction segment is adjusted in a variable fashion, depending on the rotation angle (α).
